(19) United States
(12) Patent Application Publication
(10) Pub. No.: US 2005/0267845 A1
(43) Pub. Date: Dec. 1, 2005

(54) Apparatus and method for sending and receiving digital rights objects in converted format between device and portable storage

(75) Inventors: Yun-sang Oh, Seoul (KR); Tae-sung Kim, Seoul (KR); Kyung-im Jung, Seongnam-si (KR); Shin-han Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/139,634

(22) Filed: May 31, 2005

Related U.S. Application Data
(60) Provisional application No. 60/575,757, filed on Jun. 1, 2004.

(30) Foreign Application Priority Data
May 31, 2004 (KR) 10-2004-0039369
Nov. 26, 2004 (KR) 10-2004-0098089

(51) Int. Cl. H04L 9/00

(52) U.S. Cl. 705/51

(57) ABSTRACT

An apparatus and method for sending and receiving a digital rights object (RO) in a converted format between a device and a portable storage are provided. The device includes a transceiver module receiving a RO from a rights issuer, an RO converter module converting the RO received by the transceiver module into a format for communication with a portable storage, an interface module for connection with the portable storage, a public-key encryption module authenticating with the portable storage connected through the interface module, a session key generation module generating a session key shared with the authenticated portable storage, and a digital rights management (DRM) agent providing the RO in the format converted by the RO converter module to the portable storage and receiving a RO in the converted format from the portable storage. The device converts the format of the RO to communicate with the portable storage.

### CROSS-REFERENCE TO RELATED APPLICATION

This application claims priority from Korean Patent Application No. 10-2004-0039369 filed on May 31, 2004 in the Korean Intellectual Property Office, Korean Patent Application No. 10-2004-0098089 filed Nov. 26, 2004 in the Korean Intellectual Property Office, and U.S. Provisional Patent Application No. 60/575,757 filed on Jun. 1, 2004, the entire disclosures of which are incorporated herein by reference.

### BACKGROUND OF THE INVENTION

1. Field of the Invention

Apparatuses and methods consistent with the present invention relate to sending and receiving a digital rights object (RO) in a converted format between a device and a portable storage, and more particularly, to converting a digital RO, which a device receives from a rights issuer, into a format for communication with a portable storage and sending and receiving the digital RO in the converted format, thereby decreasing a load on the portable storage and increasing data transmission efficiency.

2. Description of the Related Art

Recently, digital rights management (DRM) has been actively researched and developed. DRM has been used and will be used in commercial services because of the various characteristics of digital content. That is to say, unlike analog data, digital content can be copied without loss and can be easily reused, processed, and distributed, and only a small amount of cost is needed to copy and distribute the digital content. However, a large amount of cost, labor, and time are needed to produce the digital content. Thus, when the digital content is copied and distributed without permission, a producer of the digital content may lose profits, and the producer's enthusiasm for creation may be discouraged. As a result, development of digital content business may be hampered.

There have been several efforts to protect digital content. Conventionally, digital content protection has been concentrated on preventing non-permitted access to digital content, permitting only people paid charges to access the digital content. Thus, people who paid charges for the digital content are allowed to access unencrypted digital content while people who did not pay charges are not allowed access. However, when a person who paid charges intentionally distributes the digital content to other people, the digital content can be used by the other people who did not pay charges. To solve this program, DRM was introduced. In DRM, anyone is allowed to freely access encoded digital content, but a license referred to as a rights object is needed to decode and execute the digital content. Accordingly, the digital content can be more effectively protected by using DRM.

The concept of DRM will be described with reference to FIG. 1. DRM relates to management of contents (hereafter, referred to as encrypted contents) protected using a method such as encryption or scrambling and rights objects allowing access to the encrypted contents.

Referring to FIG. 1, a DRM system includes user devices 110 and 150 wanting to access content protected by DRM, a contents issuer 120 issuing content, a rights issuer 130 issuing an RO containing a right to access the content, and a certification authority 140 issuing a certificate.

In operation, the user device 110 can obtain desired content from the contents issuer 120 in an encrypted format protected by DRM. The user device 110 can obtain a license to play the encrypted content from a rights object received from the rights issuer 130. Then, the user device 110 can play the encrypted content. Since encrypted contents can be circulated or distributed freely, the user device 110 can freely transmit the encrypted content to the user device 150. The user device 150 needs the rights object to play the encrypted content. The rights object can be obtained from the rights issuer 130. Meanwhile, the certification authority 140 issues a certificate indicating that the contents issuer 120 is authentic and the user devices 110 and 150 are authorized. The certificate may be embedded into devices used by the user devices 110 and 150 when the devices are manufactured and may be reissued by the certification authority 140 after a predetermined duration has expired.

DRM protects the profits of those producing or providing digital contents and thus may be helpful in activating the digital content industry. Although a rights object or encrypted content can be transferred between the user devices (e.g., mobile devices), it is inconvenient as a practical matter. To easily move a rights object or encrypted content between devices, the efficient copying or moving of data between a device and a portable storage device acting as an intermediate between devices is desired. In addition, to prevent data copying or moving via a portable storage device from violating copyright, a method of managing copying and moving of a rights object is desired. Moreover, a method of controlling a sequence of commands used to move a rights object is desired to prevent loss of information or addition of information by an unauthorized input.

However, when an RO or encrypted content is transmitted directly between the user devices 110 and 150 without an intermediary, a large amount of cost and time is required. Accordingly, efficient data transmission between a device and a portable storage functioning as an intermediary between devices is desired to facilitate transfer of an RO or encrypted content between the devices.

### SUMMARY OF THE INVENTION

The present invention provides an apparatus and method for converting a digital RO, which a device receives from a rights issuer, into a format for communication with a portable storage and sending and receiving the digital RO in the converted format, thereby decreasing a load on the portable storage and increasing data transmission efficiency.

According to an aspect of the present invention, there is provided a device including a transceiver module receiving an RO from a rights issuer, an RO converter module converting the RO received by the transceiver module into a format for communication with a portable storage, an interface module for connection with the portable storage, a public-key encryption module authenticating with the portable storage connected through the interface module, a session key generation module generating a session key shared with the authenticated portable storage, and a DRM agent providing the RO in the format converted by the RO converter module to the portable storage and receiving an RO in the converted format from the portable storage.

According to another aspect of the present invention, there is provided a portable storage including an interface module for connection with a device, a DRM agent receiving a rights object in a format converted by the device through the interface module, interpreting the rights object, and providing a rights object in the converted format to the device, and a storage module storing the rights object received in the converted format from the DRM agent in a format supported by the portable storage.

According to still another aspect of the present invention, there is provided a method of sending and receiving a rights object in a converted format, including receiving a rights object from a rights issuer, converting the rights object into a format for communication with a portable storage, authenticating with the portable storage, and sending and receiving the rights object in the converted format to and from the authenticated portable storage.

According to a further aspect of the present invention, there is provided a method of sending and receiving a rights object in a converted format, including receiving a rights object in the converted format from a device, interpreting the rights object in the converted format, storing the interpreted rights object in a format supported by a portable storage, and providing the rights object in the converted format to the device.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram illustrating the concept of DRM;

FIG. 2 is a schematic diagram illustrating the concept of DRM using a secure multimedia card (MMC);

FIG. 3 is a block diagram of a device according to an exemplary embodiment of the present invention;

FIG. 4 is a block diagram of a secure MMC according to an exemplary embodiment of the present invention;

FIGS. 5A and 5B illustrate examples of a secure MMC RO format (SMRF) used in the present invention;

FIG. 6 illustrates a format of a right field included in the SMRFs shown in FIGS. 5A and 5B;

FIG. 7 illustrates a format of an asset field included in the SMRFs shown in FIGS. 5A and 5B;

FIG. 8 illustrates a format of a permission field included in the SMRFs shown in FIGS. 5A and 5B;

FIG. 9 illustrates a format of a permission information subfield included in the permission field shown in FIG. 8; and

FIG. 10 illustrates a format of a constraint index+constraint information field shown in FIG. 9.

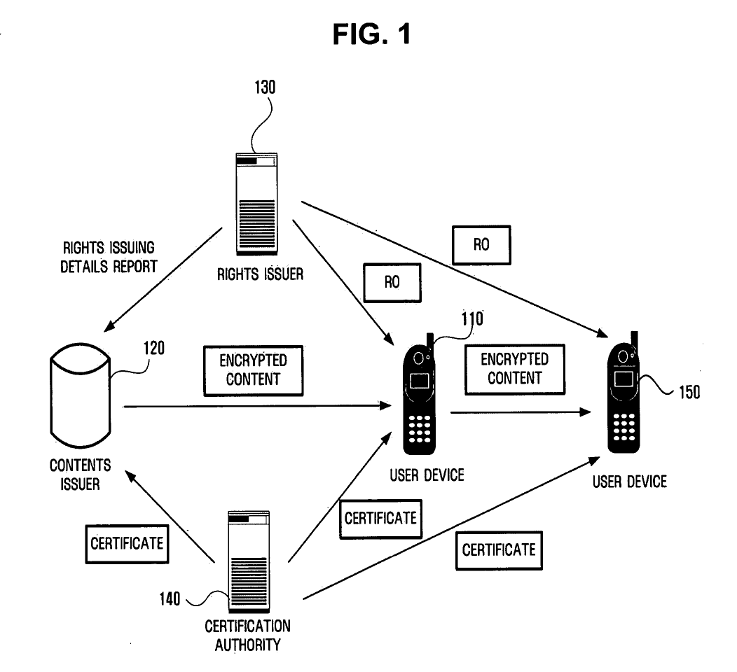

### DETAILED DESCRIPTION OF EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

Before the detailed description is set forth, terms used in this specification will be described briefly. Description of terms is to be construed provided for a better understanding of the specification and terms that are not explicitly defined herein are not intended to limit the broad aspect of the invention.

Public-Key Cryptography

Public-key cryptography is referred to as an asymmetric cipher in which a key used for encryption is different from a key used for decryption. A public-key algorithm is open to the public, but it is impossible or difficult to decrypt original content with only a cryptographic algorithm, an encryption key, and ciphered text. Examples of a public-key cryptographic system include Diffie-Hellman cryptosystems, RSA cryptosystems, ElGamal cryptosystems, and elliptic curve cryptosystems. The public-key cryptography is about 100-1000 times slower than symmetric-key cryptography and is thus usually used for key exchange and digital signature not for encryption of content.

Symmetric-Key Cryptography

Symmetric-key cryptography is a symmetric cipher referred to as secret-key cryptography using the same key encryption and decryption. A data encryption standard (DES) is a most usual symmetric cipher. Recently, applications using an advanced encryption standard (AES) have increased.

Certificate

A certification authority certifies users of a public key with respect to a public-key cipher. A certificate is a message containing a public key and a person's identity information which are signed by the certification authority using a private key. Accordingly, the integrity of the certificate can be easily considered by applying the public key of the certification authority to the certificate, and therefore, attackers are prevented from modulating a user's public key.

Digital Signature

A digital signature is generated by a signer to indicate that a document has been written. Examples of a digital signature are an RSA digital signature, an ElGamal digital signature, a DSA digital signature, and a Schnorr digital signature. When the RSA digital signature is used, a sender encrypts a message with his/her private key and sends the encrypted message to a recipient. The recipient decrypts the encrypted message. In this case, it is proved that the message has been encrypted by the sender.

Random Number

A random number is a sequence of numbers or characters with random properties. Since it costs a lot to generate a complete random number, a pseudo-random number may be used.

Portable Storage Device

A portable storage device used in the present invention includes a non-volatile memory such as a flash memory which data can be written to, read from, and deleted from and which can be connected to a device. Examples of such portable storage device are smart media, memory sticks, compact flash (CF) cards, xD cards, and multimedia cards. Hereinafter, a secure MMC will be explained as a portable storage device.

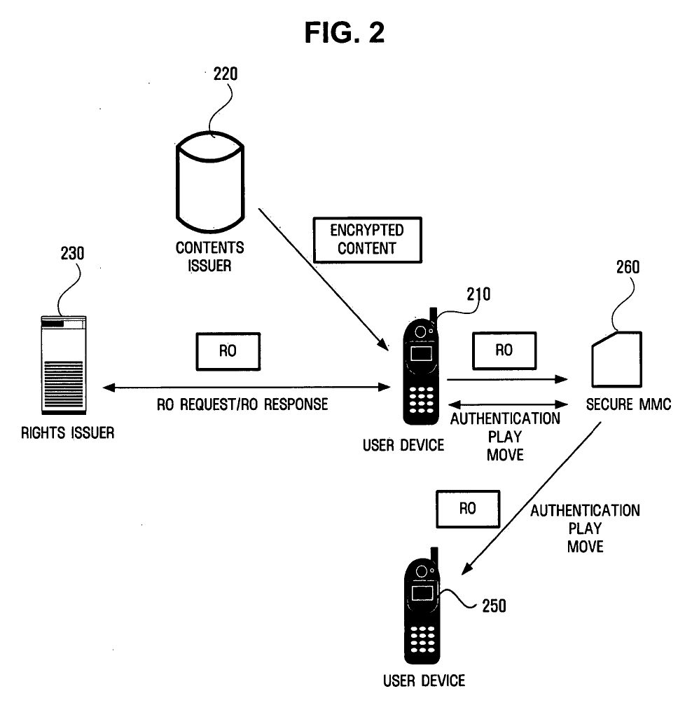

FIG. 2 is a schematic diagram illustrating the concept of DRM using a secure multimedia card (MMC).

A user device 210 can obtain encrypted content from a contents issuer 220. The encrypted content is content protected through DRM. To play the encrypted content, an RO for the encrypted content is needed. An RO contains a definition of a right to content, constraints to the right, and a right to the RO itself. An example of the right to the content may be a playback. Examples of the constraints may be the number of playbacks, a playback time, and a playback duration. An example of the right to the RO may be a move or a copy. In other words, an RO containing a right to move may be moved to another device or a secure MMC. An RO containing a right to copy may be copied to another device or a secure MMC. When the RO is moved, the original RO before the move is deactivated (i.e., the RO itself is deleted or a right contained in the RO is deleted). However, when the RO is copied, the original RO may be used in an activated state even after the copy.

After obtaining the encrypted content, the user device 210 may request an RO from a rights issuer 230 to obtain a right to play. When the user device 210 receives the RO together with an RO response from the rights issuer 230, the user device 210 can play the encrypted content using the RO. Meanwhile, the user device 210 may transfer the RO to a user device 250 having a corresponding encrypted object via a portable storage. The portable storage may be a secure MMC 260 having a DRM function. In this case, the user device 210 performs authentication with the secure MMC 260 and then moves the RO to the secure MMC 260. To play the encrypted content, the user device 210 requests a right to play from the secure MMC 260 and receives the right to play from the secure MMC 260. The user device 210 can play the encrypted content using the right to play (i.e., a content encryption key). Meanwhile, after performing the authentication with the user device 250, the secure MMC 260 allows the RO to be moved to the user device 250 and allows the user device 250 to play the encrypted content.

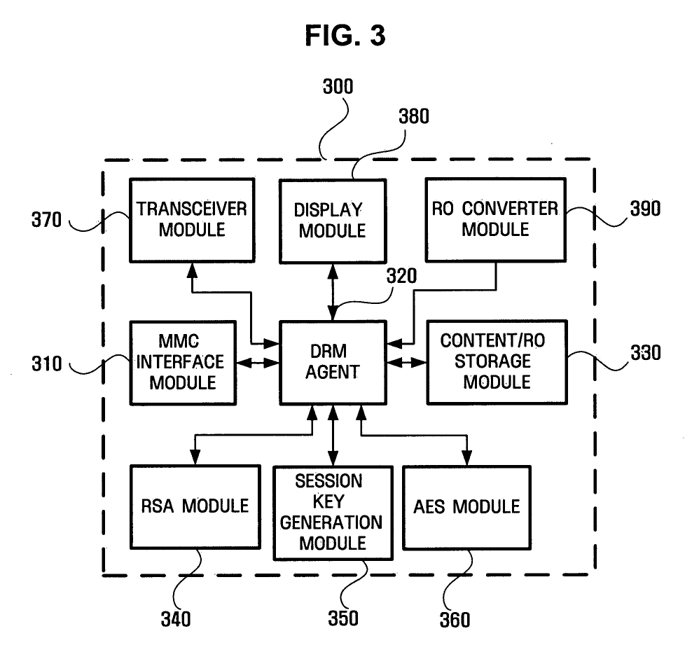

FIG. 3 is a block diagram of a device 300 according to an exemplary embodiment of the present invention.

In the exemplary embodiment, the term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a communication system.

To implement DRM, the device 300 needs a security function, a function of storing content or an RO, a function of exchanging data with another device, a data transmit/receive function allowing communication with a contents issuer or a rights issuer, and a DRM function. To perform these functions, the device 300 includes an RSA module 340, an session key generation module 350, and an advanced encryption standard (AES) module 360 for the security function; a content/RO storage module 330 with a storage function; an MMC interface module 310 allowing data exchange with a secure MMC; and a DRM agent 320 controlling each module to perform a DRM procedure. In addition, the device 300 includes a transceiver module 370 for the data transmit/receive function, an RO converter module 390 converting a format of an RO received from the rights issuer, and a display module 380 displaying content during playback.

The transceiver module 370 allows the device 300 to communicate with the content issuer or the rights issuer. The device 300 can acquire an RO or encrypted content from an outside through the transceiver module 370.

The RO converter module 390 converts a format of an RO received from the rights issuer 230 (FIG. 2) through the transceiver module 370 into a format facilitating transmission to and from a secure MMC. When the device 300 receives an RO from the rights issuer 230, rights expression language (REL) is usually extensible markup language (XML) or wireless application protocol binary XML (WBXML). Accordingly, the RO expressed in XML or WBXML is composed of an element and an attribute, which indicate a function. For example, a right to play expressed in XML is as follows.
<o-ex:rights
xmlns:o-ex=“http://odrl.net/1.1/ODRL-EX”
xmlns:o-dd=“http://odrl.net/1.1/ODRL-DD”
>
<o-ex:context>
<o-dd:version>1.0</o-dd:version>
</o-ex:context>
<o-ex:agreement>
<o-ex:asset>
<o-ex:context>
<o-dd:uid>cid:4567829547@foo.com</o-dd:uid>
</o-ex:context>
</o-ex:asset>
<o-ex:permission>
<o-dd:play/>
</o-ex:permission>
</o-ex:agreement>
</o-ex:rights>

When an RO in an XML format is transmitted from the device 300 to a secure MMC or changed by the secure MMC, the secure MMC must support the XML format to interpret the RO. However, to support the XML format, lots of resources are required. As a result, the RO in the XML format may be overhead in the secure MMC usually having less capacity than the device 300. In addition, when an RO is transmitted in the XML format, a large amount of transmission time is needed. Accordingly, in an exemplary embodiment of the present invention, the device 300 converts the XML format of an RO into a format facilitating transmission to and use in the secure MMC.

The MMC interface module 310 allows the device 300 to be connected with the secure MMC. When the device 300 is connected with a secure MMC, fundamentally, the MMC interface module 310 of the device 300 is electrically connected with an interface module of the secure MMC. However, the electrical connection is just an example, and the connection may indicate a state in which the device 300 can communicate with the secure MMC through a wireless medium without contact.

The RSA module 340 performs public-key encryption. More particularly, the RSA module 340 performs RSA encryption according to a request from the DRM agent 320. In exemplary embodiments of the present invention, during authentication, the RSA encryption is used for key (random number) exchange or digital signature. However, the RSA encryption is just an example, and other public-key encryption may be used.

The session key generation module 350 generates a random number to be transmitted to a secure MMC and generates a session key using the generated random number and a random number received from the secure MMC. The random number generated by the session key generation module 350 is encrypted by the RSA module 340 and then transmitted to the secure MMC through the MMC interface module 310. Instead of generating the random number in the session key generation module 350, the random number may be selected from a plurality of random numbers provided in advance.

The AES module 360 performs symmetric-key encryption using the generated session key. More particularly, the AES module 360 uses AES encryption to encrypt a content encryption key from an RO with the session key and to encrypt other important information during communication with another device. In an exemplary embodiment of the present invention, the session key is used to encrypt an RO during move of the RO. The AES encryption is just an example, and other symmetric-key encryption such as DES encryption may be used.

The content/RO storage module 330 stores encrypted contents and ROs. The ROs may be stored in a format converted by the RO converter module 390 or in another format in accordance with implementation of the device 300. The device 300 encrypts an RO according to the AES encryption using a unique key that cannot be read by another device or secure MMC, and decrypts the RO using the unique key to allow the RO to be moved or copied to another device or secure MMC. The encrypting of an RO using the unique key according to the symmetric-key encryption is just an example. Alternatively, an RO may be encrypted using a private key of the device 300 and may be decrypted using a public key of the device 300 when necessary.

The display module 380 visually displays playback of content whose RO permits playback. The display module 380 may be implemented by a liquid crystal display (LCD) device such as a thin-film transistor (TFT) LCD device or an organic electroluminescent (EL) display device.

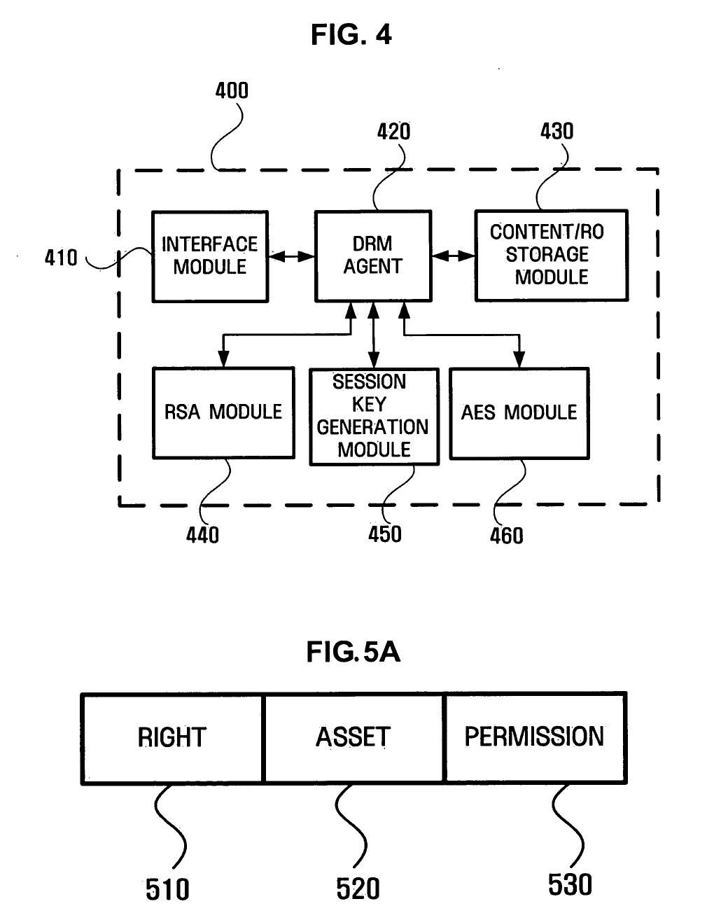

FIG. 4 is a block diagram of a secure MMC 400 according to an exemplary embodiment of the present invention.

To implement a DRM procedure, the secure MMC 400 needs a security function, a function of storing content or an RO, a function of exchanging data with a device, and a DRM function. To perform these functions, the secure MMC 400 includes an RSA module 440, a session key generation module 450, and an advanced encryption standard (AES) module 460 for the security function, a content/RO storage module 430 with a storage function, an interface unit 410 allowing data exchange with the device, and a DRM agent 420 controlling each module to perform the DRM procedure.

The interface unit 410 allows the secure MMC 400 to be connected with a device. When the secure MMC 400 is connected with the device, fundamentally, the MMC interface module 410 of the secure MMC 400 is electrically connected with an interface module of the device. However, the electrical connection is just an example, and the connection may indicate a state in which the secure MMC 400 can communicate with the device through a wireless medium without contact.

The DRM agent 420 controls each module to perform the DRM procedure. Meanwhile, the DRM agent 420 receives the RO in the converted format, interprets the received RO and provides the same to the device.

The RSA module 440 performs public-key encryption. More particularly, the RSA module 440 performs RSA encryption according to a request from the DRM agent 420. In exemplary embodiments of the present invention, during authentication, the RSA encryption is used for key (random number) exchange or digital signature. However, the RSA encryption is just an example, and other public-key encryption may be used.

The session key generation module 450 generates a random number to be transmitted to the device and generates a session key using the generated random number and a random number received from the device. The random number generated by the session key generation module 450 is encrypted by the RSA module 440 and then transmitted to the device through the interface unit 410. Meanwhile, instead of generating the random number in the session key generation module 450, the random number may be selected from a plurality of random numbers provided in advance.

The AES module 460 performs symmetric-key encryption using the generated session key. More particularly, the AES module 460 uses AES encryption to encrypt a content encryption key from an RO with the session key and to encrypt other important information during communication with the device. The AES encryption is just an example, and other symmetric-key encryption such as DES encryption may be used.

The content/RO storage module 430 stores encrypted contents and ROs. The secure MMC 400 encrypts an RO according to the AES encryption using a unique key that cannot be read by the device, and decrypts the RO using the unique key to allow the RO to be moved or copied to the device. The encrypting of an RO using the unique key according to the symmetric-key encryption is just an example. Alternatively, an RO may be encrypted using a private key of the secure MMC 400 and may be decrypted using a public key of the secure MMC 400 when necessary.

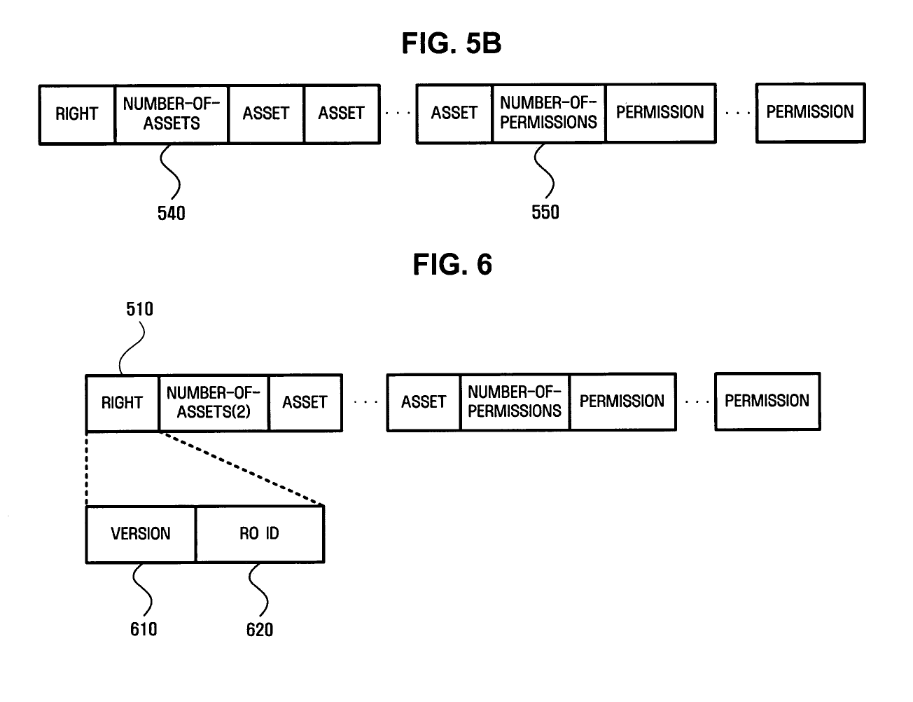

FIGS. 5A and 5B illustrate examples of a secure MMC RO format (SMRF) used in the present invention.

The SMRF includes a Right field 510, an Asset field 520, and a Permission field 530 and may include at least two Asset fields and at least two Permission fields. When the SMRF includes at least two Asset fields, it may include a Number-of-assets field 540 indicating the number of Asset fields. When the SMRF includes at least two Permission fields, it may include a Number-of-permissions field 550 indicating the number of Permission fields.

Referring to FIG. 6, the Right field 510 includes a Version field 610 containing version information of an RO and an RO identifier (ID) field 620. The Asset field 520 contains information regarding content data, the consumption of which is managed by the RO. The Permission field 530 contains information regarding an actual usage or action permitted by a rights issuer with respect to the protected content data.

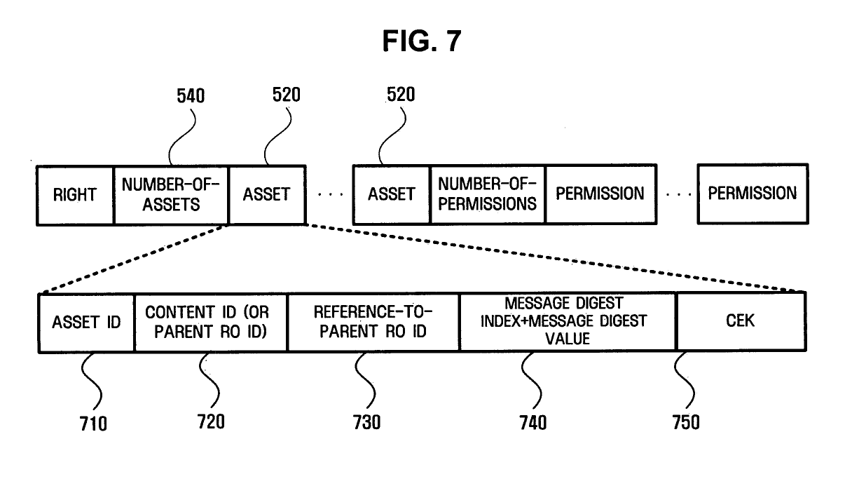

FIG. 7 illustrates a format of the Asset field 520 included in the SMRFs shown in FIGS. 5A and 5B.

The Asset field 520 includes an Asset ID field 710 for identifying a unique asset, a Content ID (or a Parent RO ID) field 720, a Reference-to-parent RO ID field 730, a Message digest index+message digest value field 740, and a Content encryption key (CEK) field 750.

When the RO is a parent RO, the Parent RO ID field 720 instead of the Content ID field is included. When the RO is a child RO, the Reference-to-parent RO ID field 730 is included.

Here, the parent RO and the child RO are in a relationship in which one RO is defined by inheriting a permission and a constraint from another RO. The parent RO defines a permission and a constraint for DRM content and the child RO inherits them. The child RO refers to the content. However, the parent RO does not directly refer to the content itself but refers to its child RO. When access to the content is permitted according to permission information regarding the child or parent RO, a DRM agent considers a constraint on the permission granting the access and all upper level constraints on the parent and child ROs. As a result, a rights issuer can support a subscription business model.

The Message digest index+message digest value field 740 is provided to protect the integrity of reference to the content. The message digest value is a value generated by a public hash algorithm, e.g., a security hash algorithm1 (SHA1). The message digest index indicates a type of hash algorithm used to generate the message digest value.

The CEK field 750 contains a binary key value used to encrypt the content. The CEK is also a key value used by a device to decrypt the encrypted content. The device can use the content by receiving the CEK from a secure MMC.

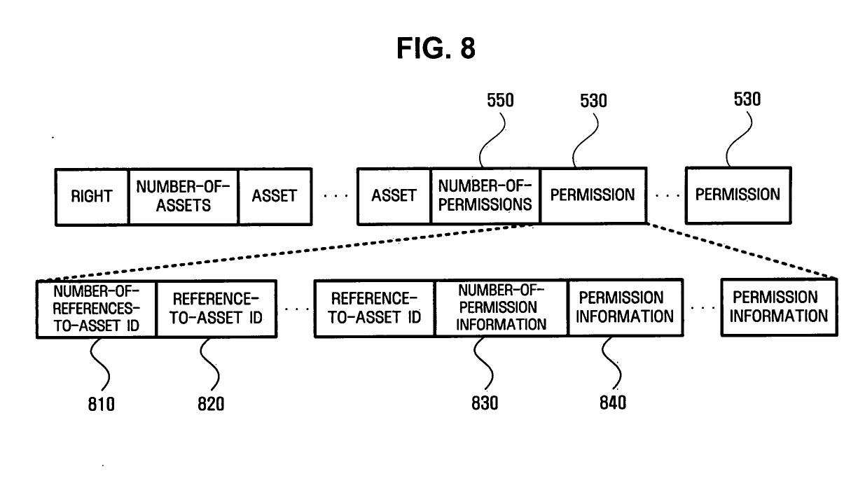

FIG. 8 illustrates a format of the Permission field 530 included in the SMRFs shown in FIGS. 5A and 5B.

The Permission field 530 includes a Reference-to-asset ID field 820 and a Permission information field 840. When at least two Reference-to-asset ID fields 820 or at least two Permission information fields 840 are included, a Number-of-references-to-asset ID field 810 or a Number-of-permission information field 830 may be included. A reference to an asset ID refers to the Asset ID field 710 shown in FIG. 7.

An RO may have a Play permission, a Display permission, an Execute permission, a Print permission, an Export permission, a Copy permission, and a Move permission. The Play permission indicates a right to express DRM content in an audio/video format. A DRM agent does not allow an access based on Play with respect to content such as JAVA games that cannot be expressed in the audio/video format.

The Play permission may optionally have a constraint. If a specified constraint is present, the DRM agent grants a right to Play according to the specified constraint. If no specified constraints are present, the DRM agent grants unlimited Play rights.

The Display permission indicates a right to display DRM content through a visual device. A DRM agent does not allow an access based on Display with respect to content such as Graphic Interchange Format (GIF) or Joint Photographic Experts Group (JPEG) images that cannot be displayed through the visual device.

The Execute permission indicates a right to execute DRM content such as JAVA games and other application programs. The Print permission indicates a right to generate a hard copy of DRM content such as JPEG images.

The Export permission indicates a right to send DRM contents and corresponding ROs to a DRM system other than an open mobile alliance (OMA) DRM system or a content protection architecture. The Export permission must have a constraint. The constraint specifies a DRM system of a content protection architecture to which DRM content and its RO can be sent. The Export permission is divided into a move mode and a copy mode. When an RO is exported from a current DRM system to another DRM system, the RO is deleted from the current DRM system in the move mode but is not deleted from the current DRM system in the copy mode.

The Move permission is divided into a device-to-secure MMC move and a secure MMC-to-device move. In the device-to-secure MMC move, an RO in a device is sent to a secure MMC and the original RO in the device is deactivated. Similar operations are performed in the secure MMC-to-device move.

The Copy permission is divided into a device-to-secure MMC copy and a secure MMC-to-device copy. In the device-to-secure MMC copy, an RO in a device is sent to a secure MMC, but unlike the Move permission, the original RO in the device is not deactivated. Similar operations are performed in the secure MMC-to-device copy.

The Number-of-permission information field 830 indicates the number of permissions. The Permission information field 840 contains information, such as a constraint, regarding a permission.

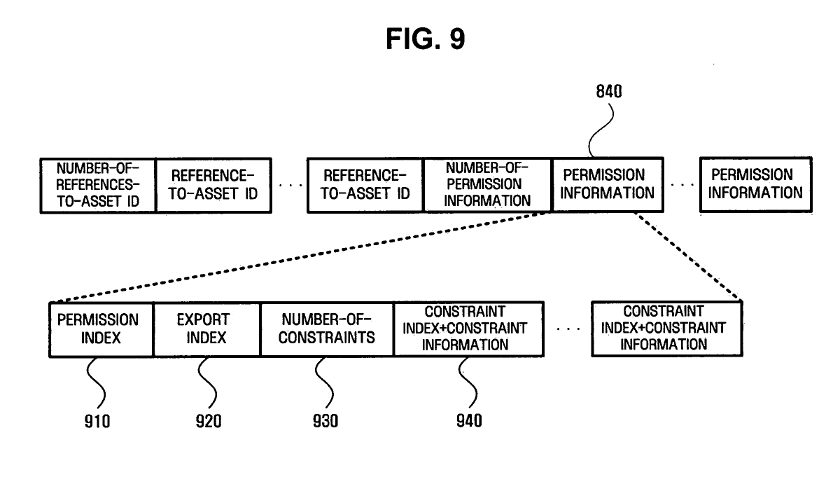

Referring to FIG. 9, the Permission information field 840 includes a Permission index field 910, an Export index field 920, a Number-of-constraints field 930, and a Constraint index+constraint information field 940. The Number-of-constraints field 930 may be omitted when there is only one Constraint index+constraint information field 940. The Permission index field 910 indicates a type of permission and has one of the values shown in Table 1.

TABLE 1

| Permission name | Permission index |
|---|---|
| All | 0x00 |
| Play | 0x01 |
| Display | 0x02 |
| Execute | 0x03 |
| Print | 0x04 |
| Export | 0x05 |
| Move | 0x06 |
| Copy | 0x07 |

The Export index field 920 is used when a permission index indicates Export to identify one of an export using a copy process and an export using a move process.

The Permission information field 840 includes information regarding part or all of the constraints shown in Table 2. Constraint information restricts the consumption of digital content. Table 2 shows types of constraints. A constraint index contained in the Constraint index+constraint information field 940 has one of the values shown in Table 2 and indicates a type of constraint.

TABLE 2

| Constraint name | Constraint index |
|---|---|
| None | 0x00 |
| Count | 0x01 |
| Time Count | 0x02 |
| Interval | 0x03 |
| Accumulated | 0x04 |
| Datetime | 0x05 |
| Individual | 0x06 |
| System | 0x07 |

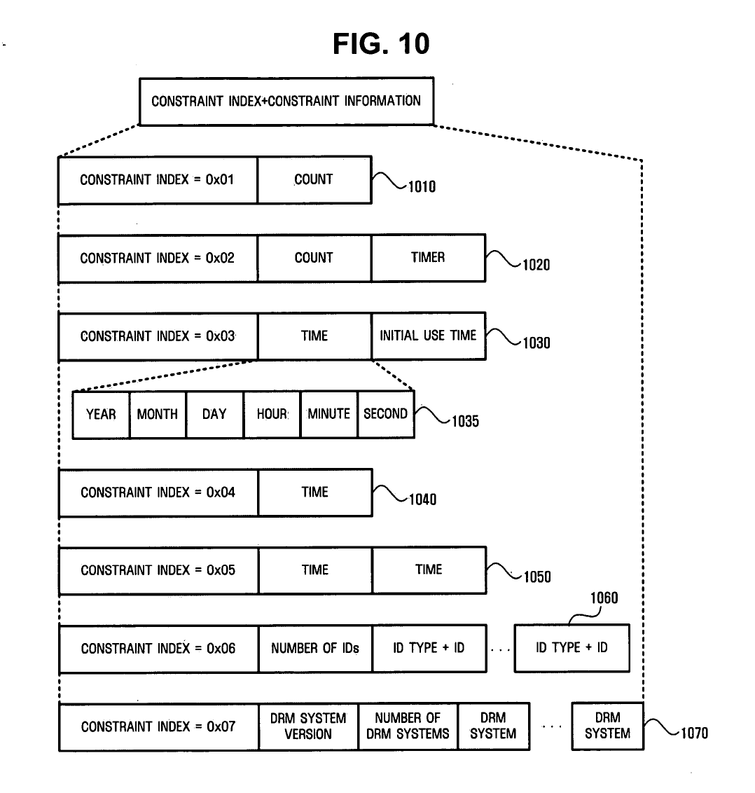

A format of the constraint index+constraint information field 940, which changes according to a value of the constraint index, will be described with reference to FIG. 10 below.

A format 1010 for a Count constraint specifies the count of permissions granted to content. A format 1020 for a Time Count constraint includes a count subfield and a timer subfield to specify the count of permissions granted to content during a period of time defined by a timer.

A format 1030 for an Interval constraint indicates that the RO can be executed for corresponding DRM content for a period of time specified in a time subfield 1035 starting from an initial use time. A format 1040 for an Accumulated constraint specifies a maximum time interval for an accumulated measured period of time while the RO is executed for corresponding DRM content. If the accumulated measured period of time exceeds the maximum time interval specified by the Accumulated constraint, a DRM agent does not permit access to the DRM content with respect to the RO. A format 1050 for a Datetime constraint includes two time subfields to specify a duration for a permission and selectively contains a start time or an end time. When the start time is contained, consumption of DRM content is permitted after a specified time and date. When the end time is contained, consumption of the DRM content is permitted by a specified time and date.

A format 1060 for an Individual constraint specifies a person to whom DRM content is bound, for example, using a Uniform Resource Locator (URL) of the person. Accordingly, if a device user's identity is not identical with the identity of the person permitted to use the DRM content, a DRM agent does not permit access to the DRM content. A format 1070 for a System constraint specifies a DRM system or a content protection architecture to which content and an RO can be exported.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

According to the present invention, a device converts an RO provided by a rights issuer into a format that does not burden a portable storage with a load before sending the RO to the portable storage, thereby reducing the load of the portable storage. In addition, when the RO is sent and received in the converted format between the device and the portable storage, transmission time can be reduced.

1. A device comprising:
a transceiver module which receives a rights object from a rights issuer;
a rights object converter module which converts the rights object received by the transceiver module into a converted format for communication with a portable storage;
an interface module which is connectable to the portable storage;
a public-key encryption module which performs authentication with the portable storage through the interface module;
a session key generation module which generates a session key shared with the portable storage; and
a digital rights management (DRM) agent which transfers the rights object converted into in the converted format by the rights object converter module to the portable storage through the interface module.

2. The device of claim 1, wherein the rights object in the converted format comprises:
version information of the rights object;
an identifier of the rights object;
an asset indicating information regarding content data to be consumed using the rights object; and
a permission indicating information regarding a right to use the content data.

3. The device of claim 2, wherein the asset comprises:
an identifier of the asset;
an identifier of one of content and a parent rights object from which the rights object is inherited;
a reference to the identifier of the parent rights object;
message digest information indicating a hash value for protecting integrity of a reference to the content; and
an encryption key used to encrypt the content.

4. The device of claim 2, wherein the permission comprises:
a reference to the identifier of the asset; and
information regarding the permission.

5. The device of claim 4, wherein the information regarding the permission comprises:
a permission index indicating a type of the permission;
an export index indicating a type of export if the permission index indicates an export; and
information regarding a constraint restricting the content of the permission according to the permission index.

6. A portable storage comprising:
an interface module which is connectable to a first device and a second device;
a digital rights management (DRM) agent which receives a rights object in a converted format from the first device through the interface module, interprets the rights object in the converted format received from the first device, and transfers the rights object in the converted format to the second device through the interface module; and
a storage module which stores the rights object in the converted format received by the DRM agent in a format supported by the portable storage.

7. The portable storage of claim 6, wherein the rights object in the converted format comprises:
version information of the rights object;
an identifier of the rights object;
an asset indicating information regarding content data to be consumed using the rights object; and
a permission indicating information regarding a right to use the content data.

8. The portable storage of claim 7, wherein the asset comprises:
an identifier of the asset;
an identifier of one of content and a parent rights object from which the rights object is inherited;
a reference to the identifier of the parent rights object;
message digest information indicating a hash value for protecting integrity of a reference to the content; and
an encryption key used to encrypt the content.

9. The portable storage of claim 7, wherein the permission comprises:
a reference to the identifier of the asset; and
information regarding the permission.

10. The portable storage of claim 9, wherein the information regarding the permission comprises:
a permission index indicating a type of the permission;
an export index indicating a type of export if the permission index indicates an export; and
information regarding a constraint restricting the content of the permission according to the permission index.

11. A method of transferring a rights object in a converted format, the method comprising:
receiving the rights object from a rights issuer;
converting the rights object into a converted format for communication with a portable storage;
performing authentication with the portable storage; and
sending the rights object in the converted format to the portable storage.

12. The method of claim 11, wherein the rights object in the converted format comprises:
version information of the rights object;
an identifier of the rights object;
an asset indicating information regarding content data to be consumed using the rights object; and
a permission indicating information regarding a right to use the content data.

13. The method of claim 12, wherein the asset comprises:
an identifier of the asset;
an identifier of one of content and a parent rights object from which the rights object is inherited;
a reference to the identifier of the parent rights object;
message digest information indicating a hash value for protecting integrity of a reference to the content; and
an encryption key used to encrypt the content.

14. The method of claim 12, wherein the permission comprises:
a reference to the identifier of the asset; and
information regarding the permission.

15. The method of claim 14, wherein the information regarding the permission comprises:
a permission index indicating a type of the permission;
an export index indicating a type of export if the permission index indicates an export; and
information regarding a constraint restricting the content of the permission according to the permission index.

16. A method of transferring a rights object in a converted format, comprising:
receiving the rights object in the converted format from a device;
interpreting the rights object in the converted format;
storing the rights object in a format supported by a portable storage; and
providing the rights object in the converted format to another device.

17. The method of claim 16, wherein the rights object in the converted format comprises:
version information of the rights object;
an identifier of the rights object;
an asset indicating information regarding content data to be consumed using the rights object; and
a permission indicating information regarding a right to use the content data.

18. The method of claim 17, wherein the asset comprises:
an identifier of the asset;
an identifier of one of content and a parent rights object from which the rights object is inherited;
a reference to the identifier of the parent rights object;
message digest information indicating a hash value for protecting integrity of a reference to the content; and
an encryption key used to encrypt the content.

19. The method of claim 17, wherein the permission comprises:
a reference to the identifier of the asset; and
information regarding the permission.

20. The method of claim 19, wherein the information regarding the permission comprises:
a permission index indicating a type of the permission;
an export index indicating a type of export if the permission index indicates an export; and
information regarding a constraint restricting the content of the permission according to the permission index.

21. A recording medium having a computer readable program recorded therein, the program for executing a method of transferring a rights object in a converted format, the method comprising:
receiving the rights object from a rights issuer;
converting the rights object into a converted format for communication with a portable storage;
performing authentication with the portable storage; and
sending the rights object in the converted format to the portable storage.

22. A recording medium having a computer readable program recorded therein, the program for executing a method of transferring a rights object in a converted format, comprising:
receiving the rights object in the converted format from a device;
interpreting the rights object in the converted format;
storing the rights object in a format supported by a portable storage; and
providing the rights object in the converted format to another device.
